(19) United States
(12) Patent Application Publication
(10) Pub. No.: US 2015/0015151 A1
(43) Pub. Date: Jan. 15, 2015

(54) Lighting Circuit and Luminaire

(71) Applicant: Toshiba Lighting & Technology Corporation, Yokosuka-shi (JP)

(72) Inventors: Toshio Tsuji, Yokosuka-shi (JP); Hiroyuki Kudo, Yokosuka-shi (JP); Tatsuya Konishi, Yokosuka-shi (JP)

(73) Assignee: Toshiba Lighting & Technology Corporation, Yokosuka-shi (JP)

(21) Appl. No.: 14/200,080

(22) Filed: Mar. 7, 2014

(30) Foreign Application Priority Data
Jul. 12, 2013 (JP) 2013-147099

(51) Int. Cl. H05B 37/02

(52) U.S. Cl. CPC H05B 37/0227
USPC 315/200 R; 315/307; 315/308

(57) ABSTRACT

A lighting circuit include a connecting section connected to a light source module to thereby form at least a first path and a second path, a power supplying section connected to the connecting section and capable of supplying first direct-current power and second direct-current power to the light source module, a detecting section configured to detect the connection of the light source module, and a control section configured to determine, when the detecting section detects the connection of the light source module, whether the light source module is connected to the first path or the second path and, when determining that the light source module is connected to the first path, cause the power supplying section to supply the first direct-current power and, when determining that the light source module is connected to the second path, cause the power supplying section to supply the second direct-current power.

### CROSS-REFERENCE TO RELATED APPLICATIONS

This application is based upon and claims the benefit of priority from Japanese Patent Application No.2013-147099, filed on Jul. 12, 2013; the entire contents of which are incorporated herein by reference.

### FIELD

Embodiments described herein relate generally to a lighting circuit and a luminaire.

### BACKGROUND

There is a lighting circuit used while being connected to a light source module including a light source such as an LED. There is a luminaire including the light source module and the lighting circuit. The lighting circuit converts an alternating-current voltage supplied from a commercial power supply or the like into a voltage corresponding to the light source module and supplies the voltage after the conversion to the light source module to thereby light the light source of the light source module. It is desired to make it possible to apply such a lighting circuit to a plurality of types of light source modules having different levels of brightness and the like.

### BRIEF DESCRIPTION OF THE DRAWINGS

FIG. 1 is a block diagram schematically showing a lighting circuit according to a first embodiment;

FIGS. 2A and 2B are block diagrams schematically showing examples of electrical connection of the lighting circuit and a light source module according to the first embodiment;

FIGS. 3A and 3B are perspective views schematically showing a luminaire according to a second embodiment; and

FIG. 4 is an exploded perspective view schematically showing a light source module according to the second embodiment.

### DETAILED DESCRIPTION

In general, according to one embodiment, there is provided a lighting circuit including a connecting section, a power supplying section, a first detecting section, and a control section. The connecting section is electrically connected to a light source module to thereby form at least two paths including a first path and a second path different from the first path. The power supplying section is electrically connected to the connecting section and is capable of supplying first direct-current power and second direct-current power different from the first direct-current power to the light source module. The first detecting section detects the connection of the light source module to the connecting section. When the first detecting section detects the connection of the light source module, the control section determines whether the light source module is connected to the first path or connected to the second path. When determining that the light source module is connected to the first path, the control section causes the power supplying section to supply the first direct-current power to the light source module. When determining that the light source module is connected to the second path, the control section causes the power supplying section to supply the second direct-current power to the light source module.

According to another embodiment, there is provided a luminaire including a lighting load and a lighting circuit. The lighting circuit includes a connecting section, a power supplying section, a first detecting section, and a control section. The connecting section is electrically connected to a light source module to thereby form at least two paths including a first path and a second path different from the first path. The power supplying section is electrically connected to the connecting section and is capable of supplying first direct-current power and second direct-current power different from the first direct-current power to the light source module. The first detecting section detects the connection of the light source module to the connecting section. When the first detecting section detects the connection of the light source module, the control section determines whether the light source module is connected to the first path or connected to the second path. When determining that the light source module is connected to the first path, the control section causes the power supplying section to supply the first direct-current power to the light source module. When determining that the light source module is connected to the second path, the control section causes the power supplying section to supply the second direct-current power to the light source module.

Embodiments are explained below with reference to the drawings.

The drawings are schematic or conceptual. Relations between thicknesses and widths of sections, ratios of the sizes among the sections, and the like are not always the same as real ones. Even if the same sections are shown, dimensions and ratios of the sections may be shown different depending on the drawings.

In this specification and the drawings, components same as the components already shown in the drawings and explained are denoted by the same reference numerals and signs and detailed explanation of the components is omitted as appropriate.

### FIRST EMBODIMENT

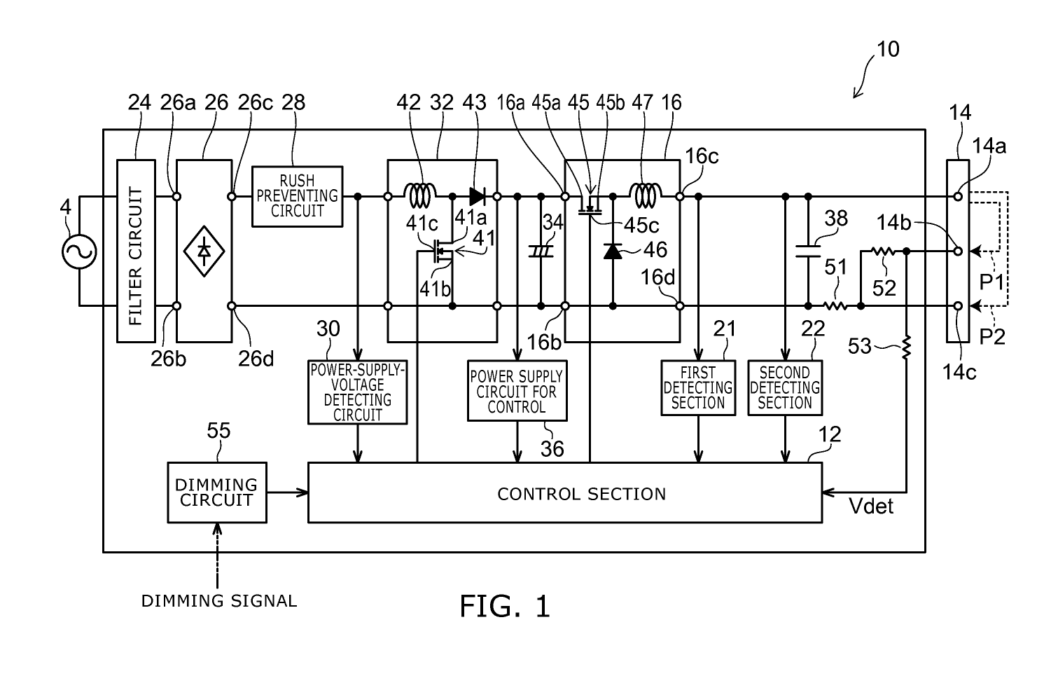

FIG. 1 is a block diagram schematically showing a lighting circuit according to a first embodiment.

As shown in FIG. 1, a lighting circuit 10 includes a control section 12, a connecting section 14, a power supplying section 16, and a first detecting section 21.

The lighting circuit 10 is electrically connected to, for example, an alternating-current power supply 4. Alternating-current power is supplied to the lighting circuit 10 from the alternating-current power supply 4. The alternating-current power supply 4 is, for example, a commercial power supply. The alternating-current power supply 4 may be, for example, a private power generator. Electric power supplied to the lighting circuit 10 may be direct-current power and the like. If the electric power supplied to the lighting circuit 10 is the direct-current power, a below-mentioned rectifier circuit 26 is omitted. In an example explained below, the alternating-current power is supplied to the lighting circuit 10.

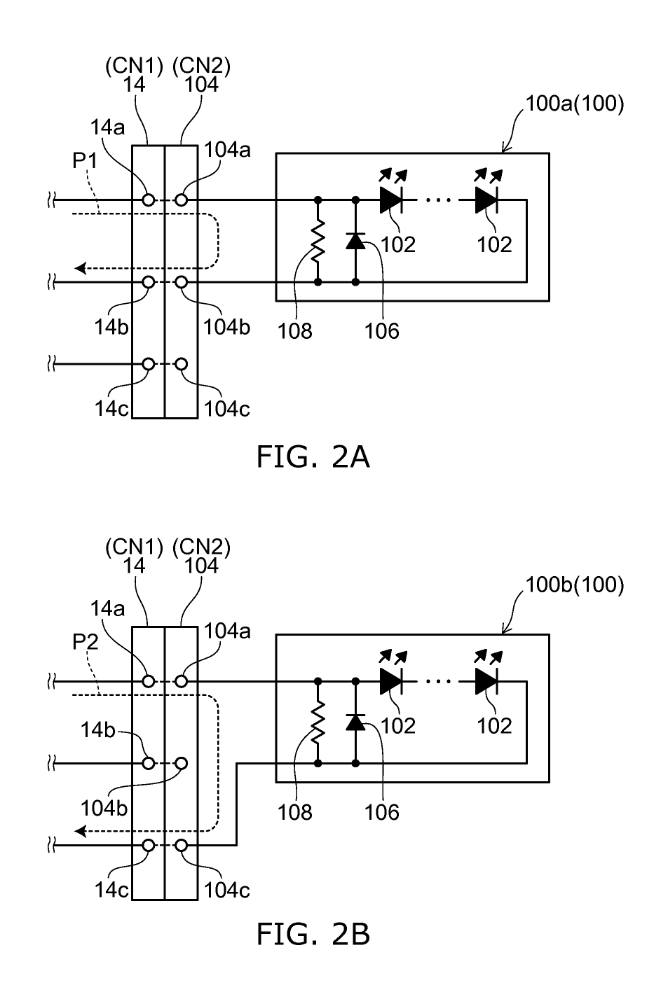

The lighting circuit 10 is electrically connected to a light source module 100 (see FIGS. 2A and 2B). The lighting circuit 10 converts the alternating-current power supplied from the alternating-current power supply 4 into direct-current power corresponding to the light source module 100 and supplies the direct-current power to the light source module 100. Consequently, the lighting circuit 10 lights the light source module 100.

The connecting section 14 is used for the electrical connection to the light source module 100. The connecting section 14 is electrically connected to the light source module 100 to thereby form at least two paths including a first path P1 and a second path P2 different from the first path P1. The connecting section 14 and the light source modules 100 are electrically connected, whereby one of the first path P1 and the second path P2 is formed. In other words, the connecting section 14 is electrically connected to the light source module 100 by one of the first path P1 and the second path P2.

The power supplying section 16 is electrically connected to the connecting section 14. The power supplying section 16 can supply first direct-current power and second direct-current power different from the first direct-current power to the light source module 100 connected to the connecting section 14.

The first detecting section 21 detects the connection of the light source module 100 to the connecting section 14. That is, the first detecting section 21 detects whether the light source module 100 is connected to the first path P1 and detects whether the light source module 100 is connected to the second path P2.

When the first detecting section 21 detects the connection of the light source module 100, the control section 12 determines whether the light source module 100 is connected to the first path P1 or connected to the second path P2. When determining that the light source module 100 is connected to the first path P1, the control section 12 causes the power supplying section 16 to supply the first direct-current power to the light source module 100. When determining that the control section is connected to the second path P2, the control section 12 causes the power supplying section 16 to supply the second direct-current power to the light source module 100.

As explained above, the lighting circuit 10 supplies the first direct-current power to the light source module 100 connected to the first path P1 and supplies the second direct-current power to the light source module 100 connected to the second path P2. Consequently, the lighting circuit 10 can be applied in common to a plurality of types of the light source module 100 having different levels of brightness, different light emission colors, and the like.

For example, the second direct-current power is set larger than the first direct-current power. The light source module 100 of a type having relatively low brightness or a relatively low color temperature (e.g., lower than 3000 lumen or equal to or lower than 4000 K) is connected to the first path P1. The light source module 100 of a type having relatively high brightness or a relatively high color temperature (e.g., equal to or higher than 3000 lumen or equal to or higher than 5000 K) is connected to the second path P2. Consequently, the lighting circuit 10 can supply appropriate power to each of the plurality of types of light source modules 100 having different levels of brightness and different color temperatures.

The lighting circuit 10 detects, with one first detecting section 21, the connection of the light source module 100 to the first path P1 and the connection of the light source module 100 to the second path P2. Consequently, for example, compared with the lighting circuit 10 including a circuit configured to detect the connection of the light source module 100 to the first path P1 and a circuit configured to detect the connection of the light source module 100 to the second path P2, it is possible to suppress an increase in the number of components. It is possible to suppress, for example, an increase in costs of the lighting circuit 10.

The lighting circuit 10 further includes, for example, a second detecting section 22, a filter circuit 24, a rectifier circuit 26, a rush preventing circuit 28, a power-supply-voltage detecting circuit 30, a power-factor improving circuit 32, a smoothing capacitor 34, a power supply circuit for control 36, and a capacitor 38.

The filter circuit 24 is electrically connected to the alternating-current power supply 4. The filter circuit 24 suppresses, for example, noise included in alternating-current power supplied from the alternating-current power supply 4.

The rectifier circuit 26 is electrically connected to the filter circuit 24. The rectifier circuit 26 rectifies an alternating-current voltage input via the filter circuit 24 and converts the alternating-current voltage into a rectified voltage. As the rectifier circuit 26, for example, a diode bridge formed by combining four rectifying devices is used. That is, the rectifier circuit 26 is a full-wave rectifier. The rectified voltage is, for example, a pulsating voltage.

The rectifier circuit 26 includes a pair of input terminals 26a and 26b, a high-potential output terminal 26c, and a low-potential output terminal 26d. The input terminals 26a and 26b are electrically connected to the filter circuit 24. The rectifier circuit 26 converts an alternating-current voltage input via the input terminals 26a and 26b into a rectified voltage and outputs the rectified voltage from the high-potential output terminal 26c and the low-potential output terminal 26d. The potential of the low-potential output terminal 26d is set to reference potential (e.g., ground potential). The potential of the high-potential output terminal 26c is set to potential higher than the potential of the low-potential output terminal 26d.

The rectifier circuit 26 may be a half-wave rectifier. The rectified voltage may be a pulsating flow subjected to full-wave rectification or may be a pulsating flow subjected to half-wave rectification. As the rectifier circuit 26, for example, a Schottky barrier diode is used. Consequently, it is possible to obtain, for example, satisfactory responsiveness.

The rush preventing circuit 28 is electrically connected to the high-potential output terminal 26c. The rush preventing circuit 28 suppresses a rush current generated when a power supply is turned on.

The power-supply-voltage detecting circuit 30 is connected to an output of the rush preventing circuit 28. The power-supply-voltage detecting circuit 30 is connected, for example, between the output of the rush preventing circuit 28 and the low-potential output terminal 26d. The power-supply-voltage detecting circuit 30 detects an abnormality of an alternating-current voltage supplied from the alternating-current power supply 4. The power-supply-voltage detecting circuit 30 detects the abnormality of the alternating-current voltage on the basis of, for example, the rectified voltage rectified by the rectifier circuit 26. For example, the power-supply-voltage detecting circuit 30 determines whether an effective value of the rectified voltage is within a predetermined range. When the effective value of the rectified voltage is not within the predetermined range, the power-supply-voltage detecting circuit 30 determines that the alternating-current voltage is abnormal. That is, when the effective value of the alternating-current voltage is excessively small or excessively large, the power-supply-voltage detecting circuit 30 determines that the alternating-current voltage is abnormal.

The power-supply-voltage detecting circuit 30 is electrically connected to the control section 12. The power-supply-voltage detecting circuit 30 outputs information indicating a detection result of the abnormality of the alternating-current voltage to the control section 12. When the abnormality of the alternating-current voltage is detected by the power-supply-voltage detecting circuit 30, the control section 12 causes the power supplying section 16 to stop the supply of the first direct-current power or the second direct-current power to the light-source module 100. Consequently, it is possible to suppress, for example, a failure of the light source module 100 due to application of an abnormal voltage.

The power-factor improving circuit 32 is connected between the output of the rush preventing circuit 28 and the low-potential output terminal 26d. The power-factor improving circuit 32 suppresses, at the rectified voltage, generation of harmonics an integer times as high as a power supply frequency. Consequently, the power-factor improving circuit 32 improves a power factor of the rectified voltage.

The power-factor improving circuit 32 includes, for example, a switching element 41, an inductor 42, and a diode 43. The switching element 41 includes electrodes 41a to 41c. One end of the inductor 42 is electrically connected to the output of the rush preventing circuit 28 (the high-potential output terminal 26c). The other end of the inductor 42 is electrically connected to the electrode 41a. The electrode 41b is electrically connected to the low-potential output terminal 26d.

An anode of the diode 43 is electrically connected to the electrode 41a. A cathode of the diode 43 is electrically connected to one end of the smoothing capacitor 34. The other end of the smoothing capacitor 34 is electrically connected to the low-potential output terminal 26d. That is, in this example, the power-factor improving circuit 32 is a rising voltage chopper circuit. The power-factor improving circuit 32 is not limited to this and may be an arbitrary circuit that can improve the power factor of the rectified voltage.

The electrode 41c is electrically connected to the control section 12. The electrode 41c is a so-called control electrode. The switching element 41 switches according to a signal received from the control section 12. For example, the power-factor improving circuit 32 causes the switching element 41 to switch and brings an input current close to a sine wave to thereby improve the power factor.

The switching element 41 is, for example, an n-channel type FET. For example, the electrode 41a is a drain, the electrode 41b is a source, and the electrode 41c is a gate. The switching element 41 may be, for example, a p-channel type FET or a bipolar transistor.

The smoothing capacitor 34 smoothes a pulsating voltage after the power factor improvement to thereby convert the pulsating voltage into a direct-current voltage.

The power supply circuit for control 36 is electrically connected to, for example, one end on a high potential side of the smoothing capacitor 34. Consequently, the direct-current voltage smoothed by the smoothing capacitor 34 is input to the power supply circuit for control 36. The power supply circuit for control 36 converts the direct-current voltage smoothed by the smoothing capacitor 34 into a driving voltage for the control section 12 and supplies the driving voltage to the control section 12. The control section 12 is driven according to power supply from the power supply circuit for control 36.

The power supplying section 16 includes a first input terminal 16a, a second input terminal 16b, a first output terminal 16c, and a second output terminal 16d. The first input terminal 16a is electrically connected to the one end on the high potential side of the smoothing capacitor 34. The second input terminal 16b is electrically connected to the low-potential output terminal 26d. Consequently, the direct-current voltage is supplied to the power supplying section 16. The first output terminal 16c is electrically connected to one end of the capacitor 38. The second output terminal 16d is electrically connected to the other end of the capacitor 38. For example, the power supplying section 16 supplies one of the first direct-current power and the second direct current power to the light source module 100 from the first output terminal 16c and the second output terminal 16d.

The power supplying section 16 includes, for example, a switching element 45, a diode 46, and an inductor 47. The switching element 45 includes an electrode 45a, an electrode 45b, and an electrode 45c. The electrode 45a is electrically connected to the first input terminal 16a. The electrode 45b is electrically connected to a cathode of the diode 46. An anode of the diode 46 is electrically connected to the low-potential output terminal 26d. One end of the inductor 47 is electrically connected to the electrode 45b. The other end of the inductor 47 is electrically connected to the first output terminal 16c. The second output terminal 16d is electrically connected to the low-potential output terminal 26d. That is, the first output terminal 16c is an output terminal on a high potential side and the second output terminal 16d is an output terminal on a low potential side. The potential of the first output terminal 16c is higher than the potential of the second output terminal 16d. Conversely, the potential of the second output terminal 16d may be set higher than the potential of the first output terminal 16c. In this example, the power supplying section 16 is a constant current circuit. More specifically, the power supplying section 16 is a falling voltage chopper circuit.

The electrode 45c is electrically connected to the control section 12. The electrode 45c is a so-called control electrode. The switching element 45 switches according to a signal received from the control section 12. For example, the control section 12 causes the switching element 45 to switch to thereby generate a direct-current voltage at both ends of the capacitor 38. Consequently, electric power is supplied from the power supplying section 16 to the light source module 100. For example, the control section 12 turns off the switching element 45 to thereby stop the supply of the electric power from the power supplying section 16 to the light source module 100. The control section 12 changes a switching period of the switching element 45 to thereby change the first direct-current power and the second direct-current power.

In this example, for example, the power supplying section 16 supplies electric power of a first constant current to the light source module 100 as the first direct-current power and supplies electric power of a second constant current to the light source module 100 as the second direct-current power. For example, a current value of the second constant current is larger than a current value of the first constant current. The current value of the first constant current is, for example, 210 mA. The current value of the second constant current is, for example, 320 mA. The current value of the first constant current and the current value of the second constant current are not limited to this. The current value of the first constant current and the current value of the second constant current only have to be set as appropriate according to, for example, brightness of irradiated light of the light source module 100. For example, the current value of the second constant current may be set smaller than the current value of the first constant current.

The first direct-current power and the second direct-current power are not limited to the electric power of the constant currents and may be, for example, electric power of constant voltages or electric power of constant power. The first direct-current power and the second direct-current power only have to be set as appropriate according to the light source module 100. The second direct-current power may be arbitrary electric power different from the first direct-current power.

The switching element 45 is, for example, an n-channel type FET. For example, the electrode 45a is a drain, the electrode 45b is a source, and the electrode 45c is a gate. The switching element 45 may be, for example, a p-channel type FET or a bipolar transistor.

The power supplying section 16 is not limited to the circuit explained above and may be an arbitrary circuit capable of supplying the first direct-current power and the second direct-current power to the light source module 100. The power supplying section 16 may be, for example, a circuit including a plurality of power supplies and configured to supply the first direct-current power from a first power supply and supply the second direct-current power from a second power supply.

The connecting section 14 includes, for example, a first connection terminal 14a, a second connection terminal 14b, and a third connection terminal 14c. In this example, the first path P1 is formed by the first connection terminal 14a and the second connection terminal 14b. The second path P2 is formed by the first connection terminal 14a and the third connection terminal 14c. The number of connection terminals included in the connecting section 14 may be four or more. The number of paths of the connecting section 14 may be three or more.

The first connection terminal 14a is electrically connected to the first output terminal 16c. The second connection terminal 14b is electrically connected to the second output terminal 16d. The third connection terminal 14c is electrically connected to the second output terminal 16d. Therefore, in the first path P1, an electric current flows from the first connection terminal 14a to the second connection terminal 14b. In the second path P2, an electric current flows from the first connection terminal 14a to the third connection terminal 14c.

In this way, in this example, the first output terminal 16c on the high potential side is provided in common and the second output terminal 16d on the low potential side is divided, whereby the first path P1 and the second path P2 are formed. Consequently, for example, it is possible to simplify a circuit configuration.

The lighting circuit 10 further includes a first resistor 51, a second resistor 52, and a third resistor 53. The first resistor 51 is electrically connected between the second output terminal 16d and the third connection terminal 14c. The second resistor 52 is electrically connected between the first resistor 51 and the second connection terminal 14b. The third resistor 53 is electrically connected between the second resistor 52 and the control section 12. A resistance value R1 of the first resistor 51 is, for example, 0.82Ω. A resistance value R2 of the second resistor 52 is, for example, 0.39χ. A resistance value R3 of the third resistor 53 is, for example, several ten kilohms to several hundred kilohms. The resistance value R3 is larger than the resistance value R2. The resistance value R3 is, for example, 100 times or more as large as the resistance value R2. If the light source module 100 is connected to the first path P1, the first resistor 51 and the second resistor 52 are connected in series and the third resistor 53 is connected in parallel to the first resistor 51 and the second resistor 52. Therefore, if the light source module 100 is connected to the first path P1, a voltage obtained by dividing, with a combined resistor of the first resistor 51 and the second resistor 52, a voltage between the first output terminal 16c and the second output terminal 16d is input to the control section 12 as a detection voltage Vdet.

On the other hand, if the light source module 100 is connected to the second path P2, the second resistor 52 and the third resistor 53 are connected in series and the second resistor 52 and the third resistor 53 are connected in parallel to the first resistor 51. In this case, since the resistance value R3 is sufficiently large with respect to the resistance value R2, the resistance value R2 of the second resistor 52 can be substantially neglected in a combined resistor of the second resistor 52 and the third resistor 53. Therefore, if the light source module 100 is connected to the second path P2, a voltage obtained by dividing, with the first resistor 51, the voltage between the first output terminal 16c and the second output terminal 16d is input to the control section 12 as the detection voltage Vdet.

The control section 12 determines, according to a difference in the detection voltage Vdet, whether the light source module 100 is connected to the first path P1 or connected to the second path P2. In this way, in the lighting circuit 10, the second resistor 52 is provided in a branching portion of the second connecting terminal 14b and the third connecting terminal 14c. That is, the second resistor 52 is provided in a branching portion on the low potential side. A voltage dividing ratio of the detection voltage Vdet input to the control section 12 is changed between the time when the light source module 100 is connected to the first path P1 and the time when the light source module 100 is connected to the second path P2. Consequently, it is possible to determine whether the light source module 100 is connected to the first path P1 or connected to the second path P2.

The first detecting section 21 is electrically connected, for example, between the first output terminal 16c and the second output terminal 16d. The first detecting section 21 detects the connection of the light source module 100 to the connecting section 14 by, for example, referring to a potential difference between the first output terminal 16c and the second output terminal 16d. In this way, the first detecting section 21 is connected further to an input side than the branching portion of the second connection terminal 14b and the third connection terminal 14c. Consequently, as explained above, it is possible to suppress an increase in the number of components. The first detecting section 21 is electrically connected to the control section 12. For example, the first detecting section 21 outputs a signal indicating a detection result to the control section 12.

For example, in a state in which the power supplying section 16 is supplying the first direct-current power or the second direct-current power to the light source module 100, when the first detecting section 21 detects disconnection of the light source module 100, the control section 12 causes the power supplying section 16 to stop the supply of the first direct-current power or the second direct-current power to the light source module 100.

For example, when the first detecting section 21 detects the connection of the light source module 100 again, the control section 12 causes the power supplying section 16 to resume the supply of the first direct-current power or the second direct-current power to the light source module 100. That is, the control section 12 determines whether the light source module 100 is connected to the first path P1 or connected to the second path P2 and causes the power supplying section 16 to supply the first direct-current power or the second direct-current power to the light source module 100 according to a determination result.

In some lighting circuit, if a light source module is once removed and power supply to the light source module is stopped, even if the light source module is connected again, the power supply to the light source module is not resumed. In this case, after the light source module is connected again, power supply from a power supply for the lighting circuit itself, that is, the alternating-current power supply 4 to the lighting circuit has to be turned off once and then turned on again.

On the other hand, in the lighting circuit 10, simply by connecting the light source module 100 again, the power supply to the light source module 100 is resumed. Consequently, for example, it is possible to improve convenience of the lighting circuit 10. For example, it is possible to improve workability in setting a luminaire including the lighting circuit 10 and the light source module 100 on a ceiling or the like.

The second detecting section 22 is electrically connected to the power supplying section 16 and detects an abnormality of a voltage applied to the light source module 100. The second detecting section 22 is electrically connected, for example, between the first output terminal 16c and the second output terminal 16d. For example, in a state in which the first direct-current power or the second direct-current power is supplied to the light source module 100, the second detecting section 22 determines whether a voltage between the first output terminal 16c and the second output terminal 16d is within a predetermined range. When the voltage between the first output terminal 16c and the second output terminal 16d is not within the predetermined range, the second detecting section 22 determines that a voltage applied to the light source module 100 is abnormal. The second detecting section 22 is electrically connected to the control section 12. The second detecting section 22 outputs, for example, a signal indicating a detection result to the control section 12.

In this way, like the first detecting section 21, the second detecting section 22 is connected further to the input side than the branching portion of the second connection terminal 14b and the third connection terminal 14c. Consequently, it is possible to further suppress an increase in the number of components of the lighting circuit 10.

When the second detecting section 22 detects the abnormality of the voltage, the control section 12 causes the power supplying section 16 to stop the supply of the first direct-current power or the second direct-current power to the light source module 100. That is, the control section 12 turns off the switching element 45. Consequently, it is possible to suppress, for example, a failure of the light source module 100 due to application of an abnormal voltage.

The lighting circuit 10 further includes a dimming circuit 55. A dimming signal is input to the dimming circuit 55 from, for example, a wall switch on the outside. The dimming signal may be, for example, an alternating-current voltage subjected to conduction angle control by a dimmer or the like. The dimming circuit 55 is electrically connected to the control section 12. For example, the dimming circuit 55 generates, on the basis of the dimming signal, a signal representing a dimming degree and inputs the signal to the control section 12. The signal representing the dimming degree is, for example, a PWM signal of a duty ratio corresponding to the dimming degree. For example, the control section 12 controls the switching of the switching element 45 on the basis of the signal input from the dimming circuit 55. Consequently, the light source module 100 is dimmed at the dimming degree corresponding to the dimming signal. The brightness of the light source module 100 is controlled according to the dimming signal.

FIGS. 2A and 2B are block diagrams schematically showing examples of electrical connection of the lighting circuit and the light source module according to the first embodiment.

As shown in FIGS. 2A and 2B, the light source module 100 includes, for example, a light source 102 and a section to be connected 104. The light source module 100 includes, for example, a plurality of the light sources 102. In this example, the light sources 102 are connected in series. For example, the light sources 102 may be connected in parallel or series connection and parallel connection of the light sources 102 may be combined. The number of the light sources 102 may be arbitrary. The number of the light sources 102 may be, for example, one.

As the light source 102, for example, a light-emitting diode (LED) is used. The light source 102 may be, for example, an organic light-emitting diode (OLED), an inorganic electroluminescence) light-emitting element, an organic electroluminescence light-emitting element, or light-emitting elements of other electroluminescent types. The light source 102 may be, for example, a bulb. In the following explanation, the light source 102 is the LED.

The light source module 100 further includes, for example, a diode 106 and a resistor 108 (a resistor for detection). The diode 106 is connected in parallel to the light sources 102 connected in series. In this case, a forward direction of the diode 106 is opposite to a forward direction of the light sources 102, which are the LEDs. Consequently, the diode 106 suppresses a backflow of an electric current to the light sources 102.

The resistor 108 is connected in parallel to the light sources 102. In the lighting circuit 10, the resistor 108 is used for detection of the connection of the light source module 100. A resistance value of the resistor 108 is, for example, 300 kΩ. The resistance value of the resistor 108 is not limited to this and may be an arbitrary value.

The detecting section 21 detects the connection of the light source module 100 to the connecting section 14 by comparing a potential difference between the first output terminal 16c and the second output terminal 16d at the time when the resistor 108 is connected to the connecting section 14 and a potential difference between the first output terminal 16c and the second output terminal 16d at the time when the resistor 108 is not connected to the connecting section 14.

Further, when detecting the connection of the light source module 100, the first detecting section 21 determines whether the potential difference between the first output terminal 16c and the second output terminal 16d is within a predetermined range. Only when the potential difference between the first output terminal 16c and the second output terminal 16d is within the predetermined range, the first detecting section 21 determines that the light source module 100 is connected. In other words, the first detecting section 21 determines whether the resistance value of the resistor 108 is within a predetermined range and, only when the resistance value of the resistor 108 is within the predetermined range, determines that the light source module 100 is connected. In this way, only when the resistor 108 having a proper resistance value is connected, the first detecting section 21 determines that the light source module 100 is connected.

If the resistance value of the resistor 108 is not in the proper range, for example, detection of connection is not input to the control section 12. Therefore, if the resistance value of the resistor 108 is not in the proper range, the light source module 100 is not lit. For example, if the resistance value of the resistor 108 is not in the proper range, the first detecting section 21 may inform the control section 12 of detection of an abnormality. Consequently, it is possible to suppress, for example, a light source module of a different product or a fraudulent light source module from being connected to the lighting circuit 10 and used.

The section to be connected 104 is electrically connected to the connecting section 14 of the lighting circuit 10. For example, the section to be connected 104 is mechanically attached to the connecting section 14. For example, the light source module 100 is connected to the first path P1 or the second path P2 of the lighting circuit 10 via the section to be connected 104.

The section to be connected 104 includes a first terminal to be connected 104a, a second terminal to be connected 104b, and a third terminal to be connected 104c. In a state in which the section to be connected 104 is attached to the connecting section 14, the first terminal to be connected 104a is electrically connected to the first connection terminal 14a. In the state in which the section to be connected 104 is attached to the connecting section 14, the second terminal to be connected 104b is electrically connected to the second connection terminal 14b. In the state in which the section to be connected 104 is attached to the connecting section 14, the third terminal to be connected 104c is electrically connected to the third connection terminal 14c.

As shown in FIG. 2A, in a light source module 100a of a first type, anodes of the light sources 102 are electrically connected to the first terminal to be connected 104a and cathodes of the light sources 102 are electrically connected to the second terminal to be connected 104b. Consequently, the light source module 100a is connected to the first path P1 by connecting the connecting section 14 and the section to be connected 104. According to the supply of the first direct-current power, an electric current flows from the first connection terminal 14a to the second connection terminal 14b and the light sources 102 are lit.

As shown in FIG. 2B, in a light source module 100b of a second type, the anodes of the light sources 102 are electrically connected to the first terminal to be connected 104a and the cathodes of the light sources 102 are electrically connected to the third terminal to be connected 104c. Consequently, the light source module 100b is connected to the second path P2 by connecting the connecting section 14 and the section to be connected 104. According to the supply of the second direct-current power, an electric current flows from the first connection terminal 14a to the third connection terminal 14c and the light sources 102 are lit.

As explained above, the electrical connection of the section to be connected 104 and the light sources 102 is changed between the light source module 100a of the type for supplying the first direct-current power and the light source module 100b of the type for supplying the second direct-current power. Consequently, it is possible to suppress the light source module 100a of the type for supplying the first direct-current power from being connected to the second path P2 by mistake to supply the second direct-current power.

As explained above, in the lighting circuit 10 and the light source module 100, simply by connecting the connecting section 14 and the section to be connected 104, it is possible to appropriately connect the light source modules 100a and 100b of the respective types to the first path P1 or the second path P2. Consequently, for example, it is possible to appropriately suppress misconnection. Further, it is possible to improve workability of attachment.

The connection of the connecting section 14 and the section to be connected 104 is mechanically limited to one direction by, for example, a recess and a projection that engage with each other. Consequently, for example, it is possible to suppress the connecting section 14 and the section to be connected 104 from being connected in a wrong direction. For example, it is possible to suppress the first connection terminal 14a from being electrically connected to the third terminal to be connected 104c.

The connecting section 14 and the section to be connected 104 are, for example, a pair of connectors CN1 and CN2 each having at least three terminals and mechanically and electrically connected to each other. For example, the connecting section 14 may include a connector for the first path P1 and a connector for the second path P2. For example, there may be a plurality of portions for mechanically connecting the connecting section 14 and the section to be connected 104.

### SECOND EMBODIMENT

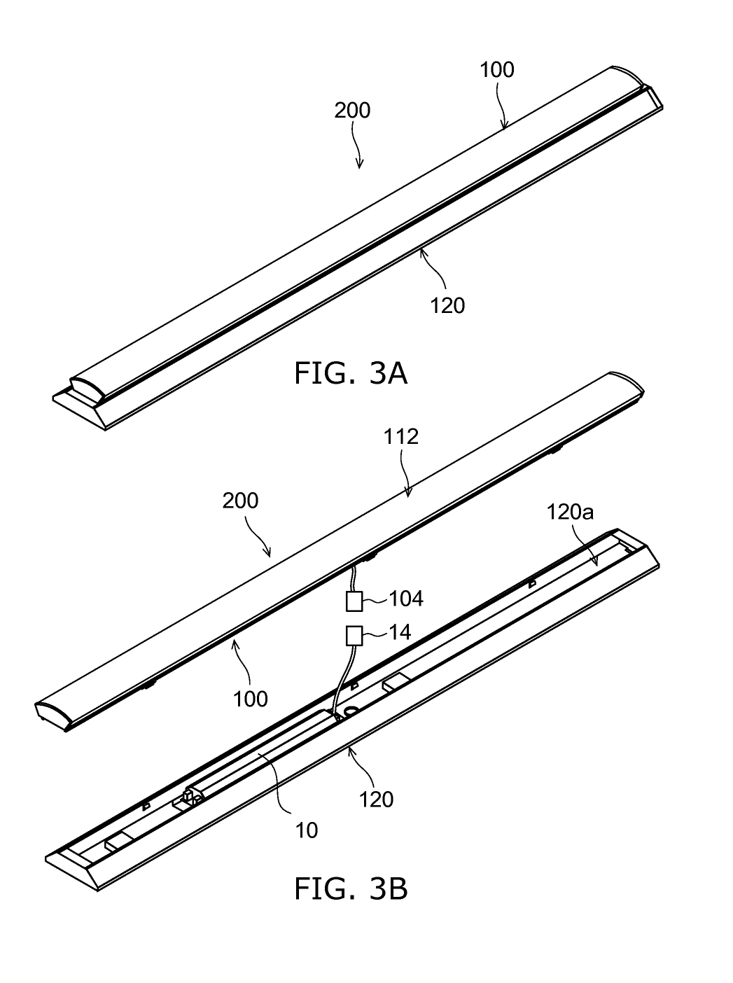

FIGS. 3A and 3B are perspective views schematically showing a luminaire according to a second embodiment.

As shown in FIGS. 3A and 3B, a luminaire 200 includes the lighting circuit 10, the light source module 100 (the light source module 100a or 100b), and a luminaire main body 120. As the lighting circuit 10 and the light source module 100, the lighting circuit 10 and the light source module 100 explained in the first embodiment are used. The luminaire main body 120 supports the lighting circuit 10 and the light source module 100.

The luminaire 200 is attached to a ceiling in a room, for example, in a state in which the light source module 100 is faced down. The luminaire 200 illuminates the room with light irradiated from the light source module 100. The luminaire 200 is not limitedly attached to the ceiling and may be attached to, for example, a wall surface. The luminaire main body 120 is attached to the ceiling by, for example, screws. In this way, the luminaire main body 120 is used to support the lighting circuit 10 and the light source module 100 and used to attach the luminaire 200 to an attachment object such as the ceiling.

The luminaire main body 120 includes a recess 120a in which at least a part of the light source module 100 is housed. For example, the lighting circuit 10 is attached to an inner bottom surface of the recess 120a. For example, the lighting circuit 10 is housed in the recess 120a.

The lighting circuit 10 is attached to the inner bottom surface of the recess 120a by, for example, screws and supported by the luminaire main body 120. The light source module 100 is attached to the luminaire main body 120 by, for example, attachment springs or screws and supported by the luminaire main body 120.

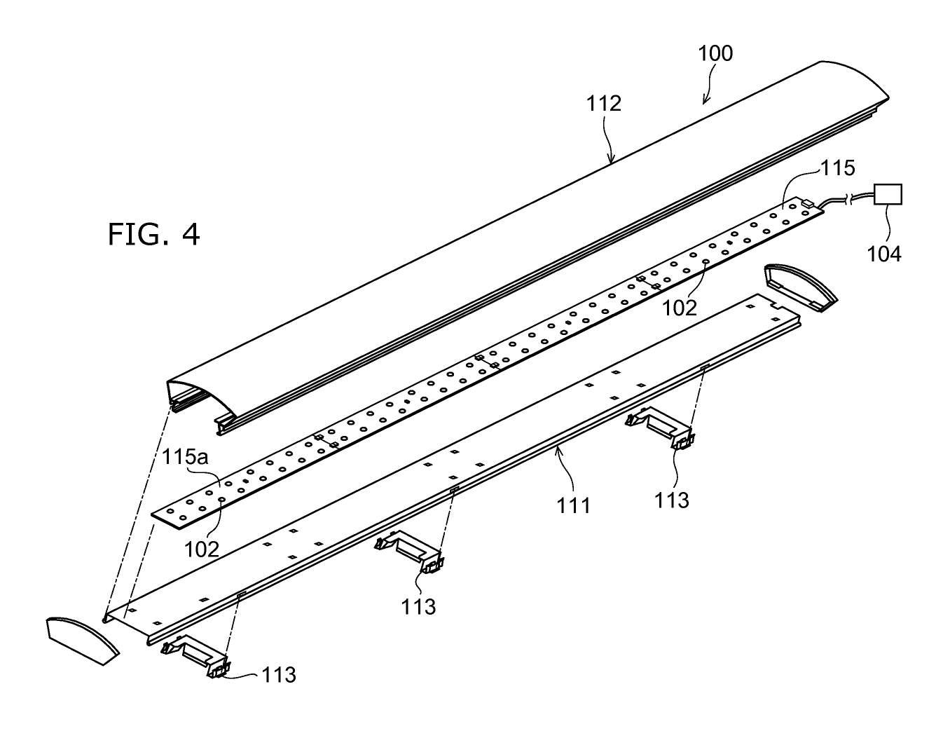

FIG. 4 is an exploded perspective view schematically showing a light source module according to the second embodiment.

As shown in FIG. 4, the light source module 100 includes a supporting body 111, a cover 112, and a holding member 113.

The supporting body 111 supports a board 115. The board 115 may be fixed to the supporting body 111 by bonding or the like or may be detachably attached to the supporting body 111 by screwing or the like. The supporting body 111 may detachably support the board 115. The light sources 102 are provided on the board 115. The light sources 102 are arranged side by side on a surface 115a of the board 115.

A not-shown wiring layer is provided on the board 115. The light sources 102 are electrically connected to one another via the wiring layer. The section to be connected 104 is electrically connected to the wiring layer via a wire. For example, the section to be connected 104 is electrically connected to the light sources 102 via the wires and the wiring layer of the board 115.

The cover 112 is attached to the supporting body 111 and covers the board 115 supported by the supporting body 111. The cover 112 protects the board 115 and the light sources 102 from, for example, an external force and dust. The cover 112 has light transmissivity. The cover 112 is light transmissive with respect to lights emitted by the light sources 102. The cover 112 is, for example, transparent. The cover 112 may have, for example, light diffusibility. For the cover 112, for example, a light transmissive resin material is used. Consequently, the lights emitted from the light sources 102 are transmitted through the cover 112 and irradiated to the outside.

The holding member 113 holds the cover 112 on the supporting body 111. That is, the holding member 113 prevents the cover 112 from coming off the supporting body 111. In the light source module 100, for example, a plurality of the holding members 113 are provided. In this example, three holding members 113 are provided. The number of the holding members 113 may be arbitrary. For example, the number of the holding members 113 may be one or two or may be four or more

If the luminaire 200 is set on the ceiling, for example, the luminaire main body 120 is screwed to a ceiling plate or the like from the interior side. In the luminaire main body 120, for example, at least two chains (not shown in the figure) for suppressing a drop of the light source module 100 are provided. For example, the two chains are provided near both ends in a longitudinal direction of the luminaire main body 120. In the supporting body 111 of the light source module 100, for example, a plurality of hooks corresponding to the chains are provided. After the luminaire main body 120 is screwed to the ceiling, ends of the chains are hung on the hooks of the light source module 100 to suspend the light source module 100.

After the light source module 100 is suspended, the lighting circuit 10 and the light source module 100 are electrically connected by connecting the connecting section 14 and the section to be connected 104. After wiring, the light source module 100 is supported by the luminaire main body 120. Consequently, the luminaire 200 is attached to the ceiling.

In this way, the lighting circuit 10 is used in the luminaire 200. Consequently, for example, in a plurality of types of the luminaires 200 having different levels of brightness and different light emission colors of the light source module 100, it is possible to apply the lighting circuit 10 in common. For example, in manufacturing of the plurality of types of the luminaires 200, it is possible to reduce the number of components. For example, it is possible to suppress manufacturing costs of the luminaire 200.

For example, after the luminaire 200 is attached to the ceiling or the like, it may be desired to change brightness, a light emission color, and the like of the light source module 100. If a lighting circuit is set for each of types of the light source module 100, it is necessary to change the lighting circuit according to replacement of the light source module 100.

On the other hand, in the luminaire 200 according to this embodiment, it is sufficient to replace only the light source module 100 with the light source module 100 of a different type and connect the light source module 100 of the different type to the lighting circuit 10. Therefore, for example, it is possible to suppress costs in changing brightness, a light emission color, and the like. For example, when the brightness, the light emission color, and the like are changed, it is unnecessary to attach and detach the lighting circuit 10. It is possible to improve workability of the replacement.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A lighting circuit comprising:
a connecting section electrically connected to a light source module to thereby form at least two paths including a first path and a second path different from the first path;
a power supplying section electrically connected to the connecting section and capable of supplying first direct-current power and second direct-current power different from the first direct-current power to the light source module;
a first detecting section configured to detect the connection of the light source module to the connecting section; and
a control section configured to determine, when the first detecting section detects the connection of the light source module, whether the light source module is connected to the first path or connected to the second path and, when determining that the light source module is connected to the first path, cause the power supplying section to supply the first direct-current power to the light source module and, when determining that the light source module is connected to the second path, cause the power supplying section to supply the second direct-current power to the light source module.

2. The circuit according to claim 1, wherein
the power supplying section includes a first output terminal and a second output terminal and supplies one of the first direct-current power and the second direct-current power to the light source module from the first output terminal and the second output terminal,
the connecting section includes a first connection terminal electrically connected to the first output terminal, a second connection terminal electrically connected to the second output terminal, and a third connection terminal electrically connected to the second output terminal, the first path being formed by the first connection terminal and the second connection terminal and the second path being formed by the first connection terminal and the third connection terminal, and
potential of the first output terminal is higher than potential of the second output terminal.

3. The circuit according to claim 2, further comprising a resistor provided in a branching portion of the second connection terminal and the third connection terminal, wherein
a voltage dividing ratio of a detection voltage input to the control section is changed between time when the light source module is connected to the first path and time when the light source module is connected to the second path.

4. The circuit according to claim 1, further comprising a second detecting section electrically connected to the power supplying section and configured to detect an abnormality of a voltage applied to the light source module, wherein
when the second detecting section detects the abnormality of the voltage, the control section causes the power supplying section to stop the supply of the first direct-current power or the second direct-current power to the light source module.

5. The circuit according to claim 1, further comprising:
a rectifier circuit configured to rectify an alternating-current voltage supplied from an alternating-current power supply and convert the alternating-current voltage into a rectified voltage; and
a smoothing capacitor configured to smooth the rectified voltage and convert the rectified voltage into a direct-current voltage, wherein
the power supplying section converts the direct-current voltage into the first direct-current power or the second direct-current power.

6. The circuit according to claim 5, further comprising a power-factor improving circuit configured to improve a power factor of the rectified voltage, wherein
the smoothing capacitor smoothes the rectified voltage after the power factor improvement.

7. The circuit according to claim 1, wherein
the light source module includes:
a light source; and
a resistor for detection connected in parallel to the light source, and
the first detecting section detects the connection of the light source module to the connecting section by comparing a potential difference at time when the resistor for detection is connected to the connecting section and a potential difference at time when the resistor for detection is not connected to the connecting section.

8. The circuit according to claim 7, wherein, when detecting the connection of the light source module, the first detecting section determines whether the potential difference is within a predetermine range and, only when the potential difference is within the predetermine range, determines that the light source module is connected.

9. The circuit according to claim 1, wherein
the light source module includes a section to be connected mechanically attached to the connecting section and electrically connected to the connecting section, and
the connecting section forms the first path or the second path when the section to be connected is connected to the connecting section.

10. The circuit according to claim 1, wherein
the power supplying section is a chopper circuit including a switching element, a diode, and an inductor, and
the control section controls switching of the switching element to thereby cause the power supplying section to supply the first direct-current power or the second direct-current power.

11. A luminaire comprising:
a light source module; and
a lighting circuit including:
a connecting section electrically connected to the light source module to thereby form at least two paths including a first path and a second path different from the first path;
a power supplying section electrically connected to the connecting section and capable of supplying first direct-current power and second direct-current power different from the first direct-current power to the light source module;
a first detecting section configured to detect the connection of the light source module to the connecting section; and
a control section configured to determine, when the first detecting section detects the connection of the light source module, whether the light source module is connected to the first path or connected to the second path and, when determining that the light source module is connected to the first path, cause the power supplying section to supply the first direct-current power to the light source module and, when determining that the light source module is connected to the second path, cause the power supplying section to supply the second direct-current power to the light source module.

12. The luminaire according to claim 11, wherein
the power supplying section includes a first output terminal and a second output terminal and supplies one of the first direct-current power and the second direct-current power to the light source module from the first output terminal and the second output terminal,
the connecting section includes a first connection terminal electrically connected to the first output terminal, a second connection terminal electrically connected to the second output terminal, and a third connection terminal electrically connected to the second output terminal, the first path being formed by the first connection terminal and the second connection terminal and the second path being formed by the first connection terminal and the third connection terminal, and
potential of the first output terminal is higher than potential of the second output terminal.

13. The luminaire according to claim 12, wherein
the lighting circuit further includes a resistor provided in a branching portion of the second connection terminal and the third connection terminal, and
a voltage dividing ratio of a detection voltage input to the control section is changed between time when the light source module is connected to the first path and time when the light source module is connected to the second path.

14. The luminaire according to claim 11, wherein
the lighting circuit further includes a second detecting section electrically connected to the power supplying section and configured to detect an abnormality of a voltage applied to the light source module, and
when the second detecting section detects the abnormality of the voltage, the control section causes the power supplying section to stop the supply of the first direct-current power or the second direct-current power to the light source module.

15. The luminaire according to claim 11, wherein the lighting circuit further includes:
a rectifier circuit configured to rectify an alternating-current voltage supplied from an alternating-current power supply and convert the alternating-current voltage into a rectified voltage; and
a smoothing capacitor configured to smooth the rectified voltage and convert the rectified voltage into a direct-current voltage, and
the power supplying section converts the direct-current voltage into the first direct-current power or the second direct-current power.

16. The luminaire according to claim 15, wherein
the lighting circuit further includes a power-factor improving circuit configured to improve a power factor of the rectified voltage, and
the smoothing capacitor smoothes the rectified voltage after the power factor improvement.

17. The luminaire according to claim 11, wherein
the light source module includes:
a light source; an
a resistor for detection connected in parallel to the light source, and
the first detecting section detects the connection of the light source module to the connecting section by comparing a potential difference at time when the resistor for detection is connected to the connecting section and a potential difference at time when the resistor for detection is not connected to the connecting section.

18. The luminaire according to claim 17, wherein, when detecting the connection of the light source module, the first detecting section determines whether the potential difference is within a predetermine range and, only when the potential difference is within the predetermine range, determines that the light source module is connected.

19. The luminaire according to claim 11, wherein
the light source module includes a section to be connected mechanically attached to the connecting section and electrically connected to the connecting section, and
the connecting section forms the first path or the second path when the section to be connected is connected to the connecting section.

20. The luminaire according to claim 11, wherein
the power supplying section is a chopper circuit including a switching element, a diode, and an inductor, and
the control section controls switching of the switching element to thereby cause the power supplying section to supply the first direct-current power or the second direct-current power.
